(19) United States
(12) Patent Application Publication
(10) Pub. No.: US 2024/0312049 A1
(43) Pub. Date: Sep. 19, 2024

(54) COUNTER UNMANNED SYSTEMS USING POLARIMETRIC DETECTION, CLASSIFICATION, DISCRIMINATION, AND/OR IDENTIFICATION

(71) Applicant: The United States of America, as Represented by the Secretary of the Navy, Crane, IN (US)

(72) Inventors: Aaron B. Cole, Bloomington, IN (US); Anthony Hou, Pennington, NJ (US)

(73) Assignee: The United States of America, as represented by the Secretary of the Navy, Arlington, VA (US)

(21) Appl. No.: 18/607,976

(22) Filed: Mar. 18, 2024

Related U.S. Application Data
(60) Provisional application No. 63/452,578, filed on Mar. 16, 2023.

(51) Int. Cl. G06T 7/70; G06T 7/20

(52) U.S. Cl. CPC G06T 7/70; G06T 7/20; G06T 2207/10048; G06T 2207/30232

(57) ABSTRACT

Disclosed are systems, apparatus, and methods for object detection, and particularly drone or Unmanned Systems (UxS or UAV) detection and identification using polarized light, among other types of electromagnetic energy. The systems, apparatus, and methods may be implemented using at least two different operational modes. A first mode provides 360 degree passive detection, tracking, and UAV classification using stationary, non-rotating, thermal imagers with polarimetric sensors. A second mode provides for long range interrogation once an object of potential interest is detected using the first mode, for example. In aspects, the system may be configured to detect even to the level of small or miniature UAVs (e.g., Department of Defense UAV Group 1), classify those targets, track the objects moving across complex terrain, and determine whether those objects are biological or a drone of sufficient threat.

### CROSS-REFERENCE TO RELATED APPLICATIONS

The present application claims priority to U.S. Provisional Patent Application Ser. No. 63/452,578 filed Mar. 16, 2023, and entitled “COUNTER UNMANNED SYSTEMS USING POLARIMETRIC DETECTION, CLASSIFICATION, DISCRIMINATION, AND/OR IDENTIFICATION,” the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 211034US02) is assigned to the United States Government and is available for licensing for commercial purposes. Licensing and technical inquiries may be directed to the Technology Transfer Office, Naval Surface Warfare Center Crane, email: Crane_T2@navy.mil.

### FIELD

The field of the present disclosure relates generally to counter unmanned systems (CUxS) using polarimetric detection, classification, discrimination, and/or identification. More particularly, the present disclosure pertains to CUxS or other detection systems using polarimetric detection, classification, discrimination, and/or identification to differentiate and accurately detect unmanned aerial vehicles (UAVs) and/or similar aerial devices or drones.

### BACKGROUND

Drone detection is the practice and method of detecting unmanned aerial vehicles (UAVs) and/or similar aerial devices or drones. Reliable drone detection is a major and urgent need throughout the Department of Defense (DoD). Existing drone detection methods are used extensively in the military, law enforcement, and security fields to monitor airspace against unwanted drones. All of these existing methodologies are active, however, which means that they emit some kind of signal that a drone can use to avoid being detected. Currently, the most reliable market options for detecting UAVs include radio frequency (RF) detection and radar. To a lesser extent, there are short range optical technologies such as thermal cameras and acoustic sensors. The primary challenges of both of these technologies are range performance, military “covertness”, and, in some RF instances, electromagnetic spectrum management.

RF and network based drone trackers are some of the most widely used detection systems currently available. They are effective because many common drones send and receive radio signals between the drone and the operator. However, these type of trackers will not work against drones that are fully autonomous (i.e., no RF signals passing between the drone and the operator). Additionally, RF drone trackers are less effective in areas where many RF signals present, and their range is limited and/or inconsistent, especially in areas with physical barriers.

Other systems include radar detection of drones by using reflected radio energy to detect a UAV's presence and determine its location. Pulsating Doppler radar systems can be calibrated to detect and sometimes identify drones up to 3 miles away with excellent precision. Limitations to radar include differentiating between non-drone objects (e.g., differentiating whether to classify as a bird (or other non-drone object) or a UAV), and frequency management is required to deconflict and prevent interference. In some locations, like airports, it is not possible to deconflict interference and, therefore, the RF drone detection systems are required to be turned off.

Thermal or visual cameras can be used to detect drones as well. These systems can be effective for identifying the type of drone, as well as information about the drone payload. There are many limitations with these systems, however, such as false alarms, the range performance is less than RF, or they can be difficult to use in low visibility conditions such as darkness, fog, smoke, or other low visibility conditions.

Accordingly, there is a need for drone detection apparatus and methods that are not impacted by the signal environment, can discriminate between objects of interest and everything else, and can detect objects at a distance independent of lighting or weather conditions.

### SUMMARY

The present disclosure relates to a Counter Unmanned System (CUxS) solution that exploits polarization of light as a novel approach to detect and identify objects. In particular, the present disclosure may relate to detection of drones and Unmanned Systems (UxS) and uses physics based intelligence to discriminate or differentiate between biological and background clutter such as birds, trees, mountains, clouds, etc. and manmade objects or things such as planes, drones, warfighters, and vehicles. The polarimetric based system passively detects Group 1 and up UxS devices at tactically relevant ranges and discriminates those from other objects such as birds, planes, or other non-drone objects. Furthermore, the system is passive and is intended to relieve operator burden by being relatively autonomous with low false alarms and no misses, and only detects objects such as UAVs with unique polarization signatures.

According to one aspect, an apparatus for detection, classification, discrimination, and/or identification of objects is disclosed. The apparatus includes a camera system configured to capture one or more images including capturing polarized light, and at least one processor communicatively coupled with the camera system and configured to receive the one or more images from the camera system and process the images to determine or identify one or more objects in the one or more images received from the camera system based on at least the polarized light.

According to yet another aspect, a method for detection, classification, discrimination, and/or identification of objects is disclosed. The method includes utilizing a camera system configured to capture one or more images and polarized light, and processing the images to determine and/or identify one or more objects in the images received from the camera system based on at least the polarized light.

Additional features and advantages of the present invention will become apparent to those skilled in the art upon consideration of the following detailed description of the illustrative embodiment exemplifying a best mode of carrying out the invention as presently perceived.

### BRIEF DESCRIPTION OF THE DRAWINGS

The detailed description of the drawings particularly refers to the accompanying figures.

FIG. 1 illustrates a block diagram of an exemplary Counter Unmanned System (CUxS) solution that utilizes polarization of light as captured by a camera system for object detection according to aspects of the present disclosure.

FIG. 2 shows a block diagram of different filtering processes or modules that may be implemented and selected for image filtering according to aspects of the present disclosure.

FIG. 3 shows a block diagram of different drone or UAV detection processes or modules that may be implemented and selected according to aspects of the present disclosure.

FIG. 4 illustrates a flow diagram of an exemplary discrimination process or method according to aspects of the present disclosure.

FIG. 5 illustrates a flow diagram of a further exemplary discrimination process or method according to aspects of the present disclosure.

FIG. 6 illustrates a flow diagram of yet a further exemplary discrimination process or method according to aspects of the present disclosure.

FIG. 7 illustrates a flow diagram of still another exemplary discrimination process or method according to aspects of the present disclosure.

FIG. 8 illustrates a front view of at least a portion of an apparatus for polarimetric imaging and detection according to aspects of the present disclosure.

FIG. 9 illustrates a tri-metric side view of the apparatus of FIG. 8 according to aspects of the present disclosure.

FIG. 10 illustrates an example of a layout or arrangement of camera types that may be used within the apparatus of FIGS. 8 and 9 according to aspects of the present disclosure.

FIG. 11 illustrates an exemplary image comparing long wave infrared (LWIR) imaging with polarimetric imaging produced with processes or methods according to aspects of the present disclosure.

FIG. 12 illustrates an example of a comparison of images generated using LWIR imaging and polarimetric imaging according to aspects of the present disclosure.

FIG. 13 illustrates an exemplary block diagram of software modules/functions and hardware implemented in the system according to aspects of the present disclosure.

FIG. 14 illustrates an exemplary block diagram of further software architecture/components implemented in the system according to aspects of the present disclosure.

FIG. 15 illustrates a flow diagram of an exemplary method for detection, classification, discrimination, and/or identification of objects according to aspects of the present disclosure.

### DETAILED DESCRIPTION

Embodiments or examples of the invention described herein are not intended to be exhaustive or to limit the invention to the precise forms disclosed. Rather, the disclosed examples or embodiments have been chosen to enable one skilled in the art to practice the present invention.

According to aspects described herein, methods and apparatus for drone or Unmanned Systems (UxS or UAV) detection and identification using polarized light, among other types of electromagnetic energy, are disclosed, which is termed herein as a polarimetric system. The disclosed polarimetric system may be implemented according to at least two different operational modes. A first mode provides 360 degree passive detection, tracking, and UAV classification using stationary, non-rotating, thermal imagers with polarimetric sensors. A second mode provides for long range interrogation once an object of potential interest is detected using the first mode, for example. In particular aspects, the polarimetric system may be configured to detect even to the level of small or miniature UAVs (e.g., Department of Defense UAV Group 1), classify those targets, track the objects moving across complex terrain, and determine whether those objects are biological or a drone of sufficient threat.

According to further aspects, the present methods and apparatus feature novel optics and polarization filtering components that were configured to meet the resolution and polarization sensitivity required to identify drones at a distance and discriminate those drones from naturally occurring biologicals. Further novel mechanical designs were developed to meet the optical alignment and stability requirements of the initial optical design, as well as methods for thermal management that do not interfere with the temperature sensitive operation of the optics and the electrical components.

Still other aspects include development of a unique, low latency network system architecture that overcomes existing latency and network delays presented by commercial off the shelf (COTS) available architectures of TCP/IP and User Datagram Protocol (UDP) interfaces. In the present apparatus and methods, custom UDP protocols were combined with a novel data transmission pipeline to ensure that system latency was minimized and image delays were nominal for very large data structures. Latency and delay are significant challenges as all of the physics based algorithms that were utilized had the potential for creating significant frame-to-frame delay, which would compound latency.

Furthermore, the present disclosure provides a novel polarimetric optical design was including several custom methods or algorithms, as well as modification of several known methods or algorithms to make them applicable to the hardware and the problem of UAV Group 1 and above drone detection and object discrimination.

For the methodology or algorithms developed, there are three distinct areas of processing: 1) image filtering; 2) image detection; and 3) object discrimination. Within those areas, notable software challenges were addressed and solved including: custom real-time destriping methodologies (i.e., removing stripes or streaks from images and videos without disrupting the original image/video method), custom temporal filters; custom polarization dependent look up tables; custom polarization quantifiers; custom image stabilization; custom aspect ratio variations over time; custom pattern of life discriminators; custom radiometric assessment of polarimetric filters; custom polarization texture analysis; custom polarization Next Unit of Computing (NUC); custom defect replacement based upon hardware; custom structural similarity index metrics; custom canny filter; custom confidence reporting; and custom track reporting.

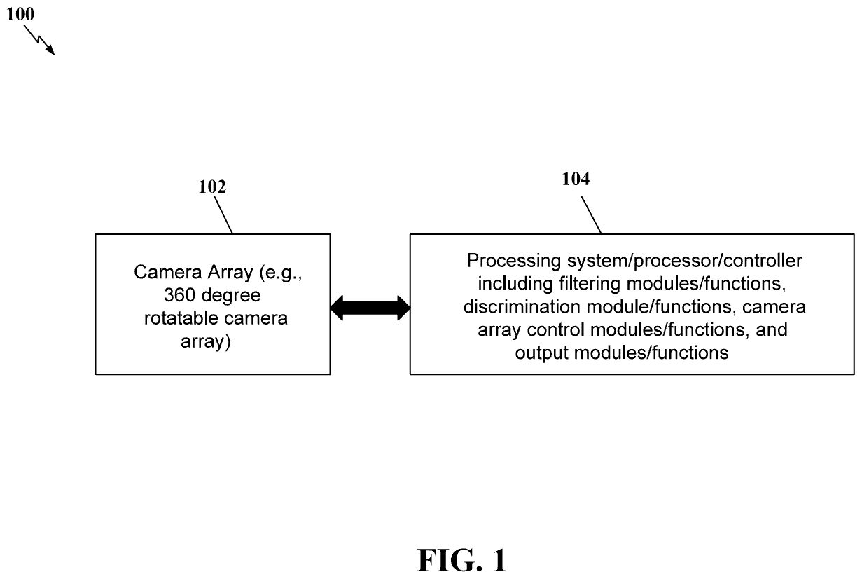

FIG. 1 illustrates a block diagram of an exemplary Counter Unmanned System (CUxS) (or simply object detection) system 100 that utilizes polarization of light (among other EM energy) as captured by a camera system for object detection according to aspects of the present disclosure. As illustrated, the system 100 includes a camera array 102, which will be discussed in more detail later, that include one or more cameras that utilize or detect polarization of light for images being captured.

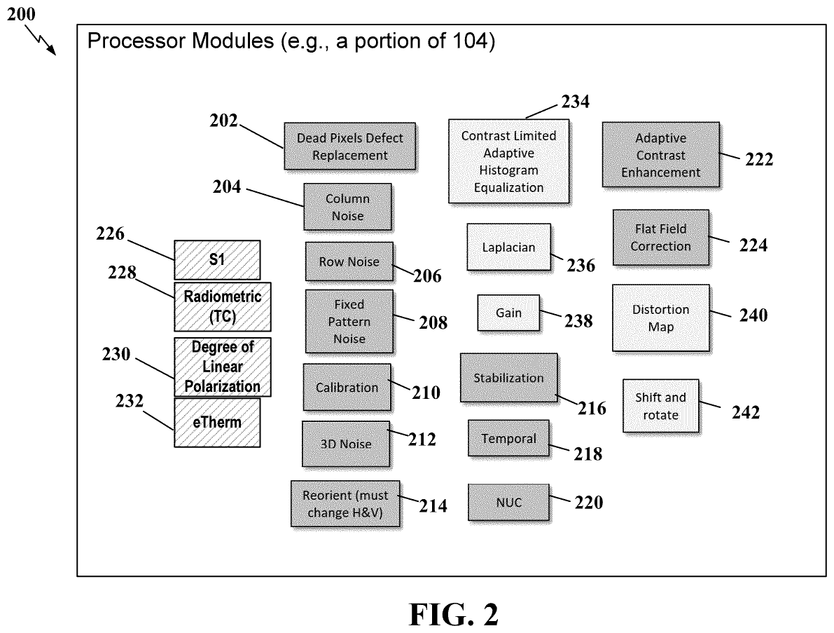

FIG. 2 shows a block diagram 200 of different filtering processes or modules that may be implemented and selected for image filtering according to aspects of the present disclosure, including implementation within or by processor 104 in FIG. 1, for example. As illustrated, the grey shaded blocks or modules indicate custom modules that may be included as part of the processor including a dead pixel defect replacement module 202, a column noise filtering module 204, a row noise filtering module 206, a fixed pattern noise filtering module 208, a calibration module 210, a 3D noise filtering module 212, a reorientation module 214, a stabilization module 216, a temporal module 218, a NUC (e.g., a custom polarization Next Unit of Computing (NUC)) 220, an adaptive contrast enhancement module 222, and a flat field correction module 224. The hashed line blocks indicates input channels including an S1 input 226, a radiometric (TC) input 228, a degree of linear polarization input 230, and an eTherm input 232. The light grey blocks are modules representing standard algorithms, but which are nonetheless applied uniquely to the system 100 including a contrast limited adaptive histogram equalization module 234, a Laplacian processing module 236, a gain function module 238, a distortion map module 240, and a shift and rotate module 242.

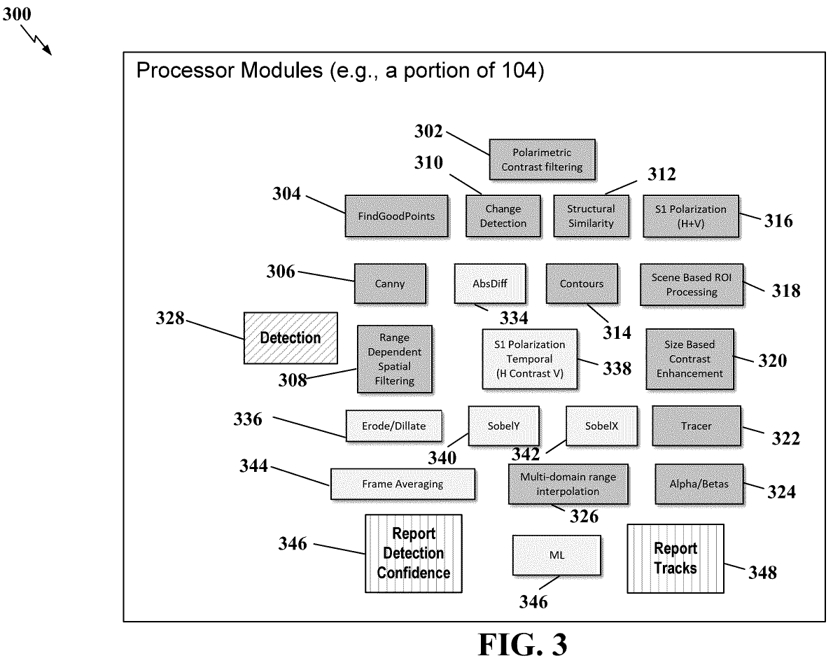

FIG. 3 illustrates a block diagram 300 of further various object or drone detection algorithms 300 that may be implemented by the processor 104, as an example and not organized in any particular manner. In this diagram, the processor 104 is shown to include one or more modules where the dark grey modules connote custom solution modules including a polarimetric contrast filtering module 302, find good points module 304, a Canny edge detection module 306, a range dependent spatial filtering module 308, a change detection module 310, a structural similarity module 312, a contours module 314, an S1 Polarization module (both horizontal (H) and vertical (V)) 316, a scene based region of interest (ROI) processing module 318, a sized based contrast enhancement module 320, an Alpha/Betas module 324, and a multi-domain range interpolation module 326. The hashed module(s) connote method requirements, including detection module 328. The modules shown in light grey connote standard algorithms that are modified to uniquely apply to the system 100 and include, an absolute difference module 334, an erode/dilate module 336, an S1 polarization temporal module 338 (i.e., H contrast with V), SobelY and SobelX modules 340, 342, a frame averaging module 344, and a machine learning (ML) module 346. Finally, the diagram 300 includes modules shown with vertical lines that connote output reports that may be displayed to a user, for example, and include a report detection confidence module 346 and a report tracks module 348.

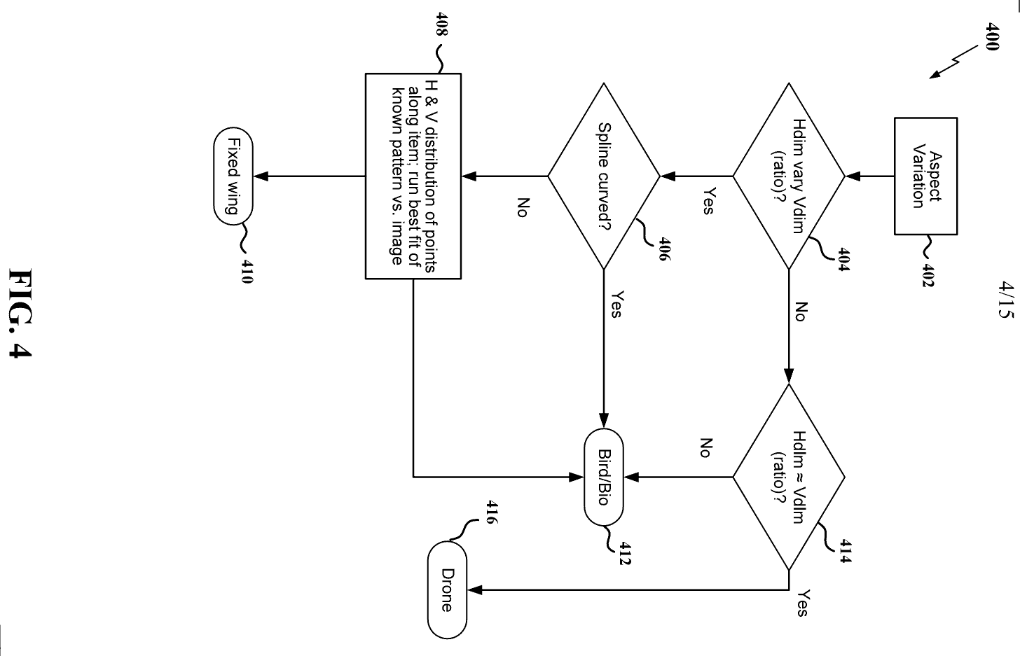

FIG. 4 illustrates a flow diagram 400 of an exemplary discrimination process or method according to aspects of the present disclosure. The illustrated discrimination algorithm 400 serves to perform discrimination between various detectable objects such as a drone, a bird or other biological creature, or a fixed wing aircraft, as examples. In particular, the process or method 400 is for differentiating aspect variation as shown by the call at block 402. Next, method 400 includes looking to see if the horizontal dimension of an image varies from the vertical dimension as shown at decision block 404. If so, flow proceeds to block 406 to determine if the spline is curved or curved above or below some threshold. If not, flow proceeds to block 408 where the horizontal and vertical (H & V) distribution of points along item are examined and best fit algorithm is run to see how known pattern(s) compare to the captured image. Based on this determination, the resultant determination may be either a fixed wing aircraft object as shown at 410 or a bird or other biologic as shown at block 412.

If the ratio of Hdim and Vdim is not varied (or varied beyond a predetermined amount) as determined at block 404, flow proceeds to decision block 414, where a determination is made whether the Hdim and Vdim values are approximately equal. If no, then the object is likely a bird/biologic and flow proceeds to block 412. In the alternative, if the ratio is close to 1:1 flow proceeds to block 416 for determination that the object is a drone/UAS.

In further aspects, it noted that process or method 400 may utilize MIL ranges to find and calculate important features. Further, in aspects the method 400 may include GUI access to allow a user to select objects in order to train the algorithm for differentiation (e.g., drone vs. fixed wing aircraft differentiation). Yet further, object size may be utilized to determine a range to the object (or target).

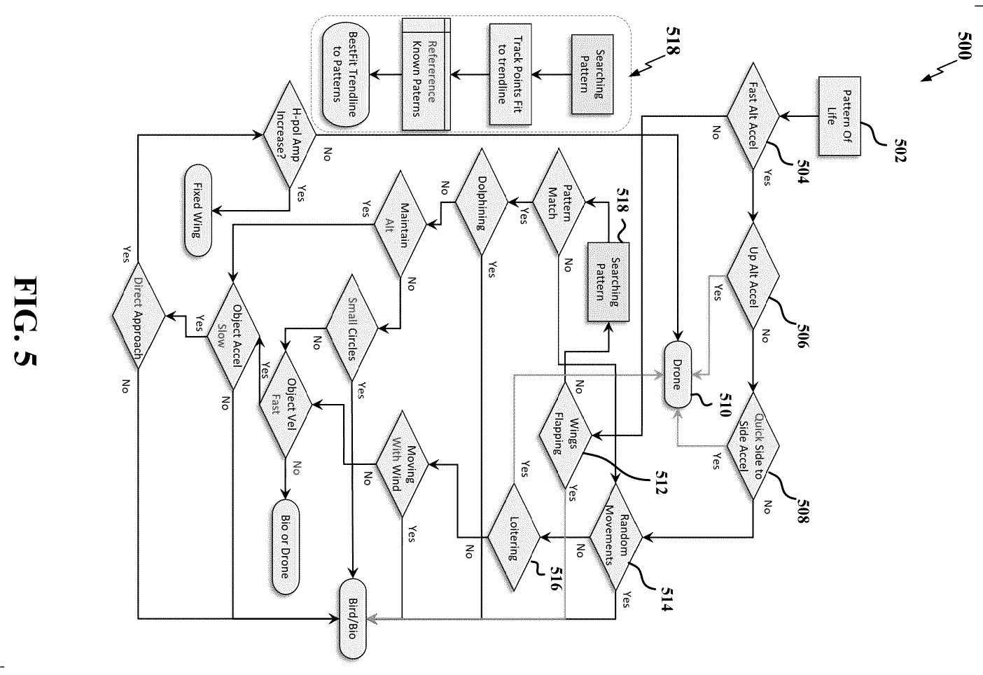

FIG. 5 illustrates a flow diagram 500 of a further exemplary discrimination process or method according to aspects of the present disclosure. The illustrated discrimination algorithm 500 serves to further discrimination between various detectable objects such as drones, birds or other biological creatures, or fixed wing aircraft including accounting for types/patterns of motion, acceleration's, velocities, etc. As shown, method 500 includes determining patterns of life for birds/biologics, as an example and shown by the call in block 502. Flow proceeds to block 504 where a determination is made whether the object captured by the camera system in one or more series of images exhibit fast altitude acceleration as shown at block 504. If the object exhibits either up altitude acceleration as determined in block 506 or quick side to side acceleration in block 508 (both indicative of non-biologic) after determining fast altitude acceleration in block 504, then a drone/UAV determination/differentiation is quickly made as shown at block 510.

As further illustrated, if other motions/patterns are exhibited when the acceleration determinations of blocks 504, 506, and 508 are not present, then other indicia are considered such as flapping motion at block 512, random movements 514 with loitering 516 may yet yield a drone/UAS determination, as shown from block 516 to block 510. Additionally, pattern-searching may utilized as shown by block 518, which entails various processes as shown at the left side of FIG. 5.

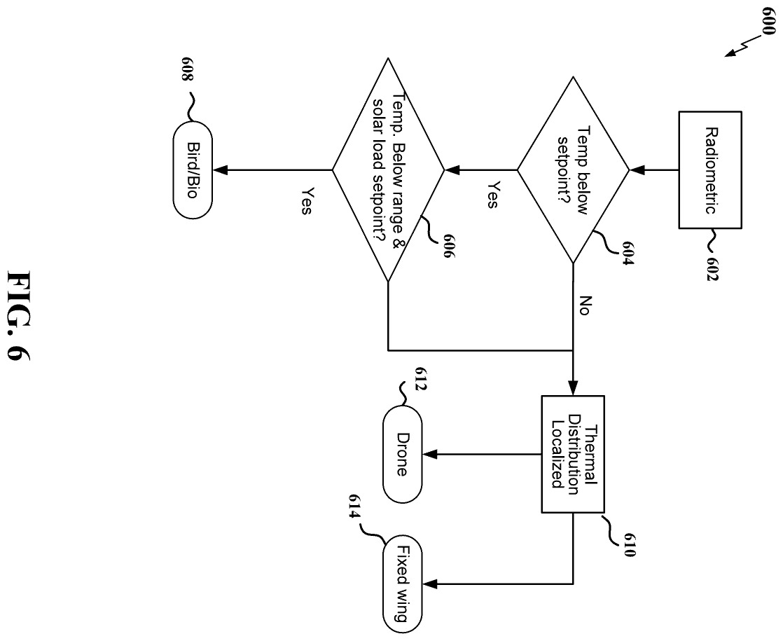

FIG. 6 illustrates a flow diagram 600 of yet a further exemplary discrimination process or method according to aspects of the present disclosure using radiometric data as indicated by the call at block 602. The illustrated discrimination algorithm 600 further serves to help the disclosed apparatus/system/processor discriminate between various detectable objects such as drones, birds or other biological creatures, or fixed wing aircraft by accounting for thermal data gathered through, among other things, radiometric data observed in the system. As illustrated, the method includes determining whether a temperature of the object is below a setpoint as illustrated by decision block 604. If yes, a next decision block 606 determines if the temperature is block a range and/or solar load setpoint. If yes, then a bird/bio determination is made as shown at block 608.

Alternatively at blocks 604 and/or 606, if the temperature is below the predetermined setpoint or above a range/solar load setpoint, then flow proceeds to block 610 where the thermal distribution of the object is considered for localization of temperature based on known distributions, in some aspects. Dependent on this determination, differentiation may be made between drones and fixed wing aircraft as shown at block 612 and 614.

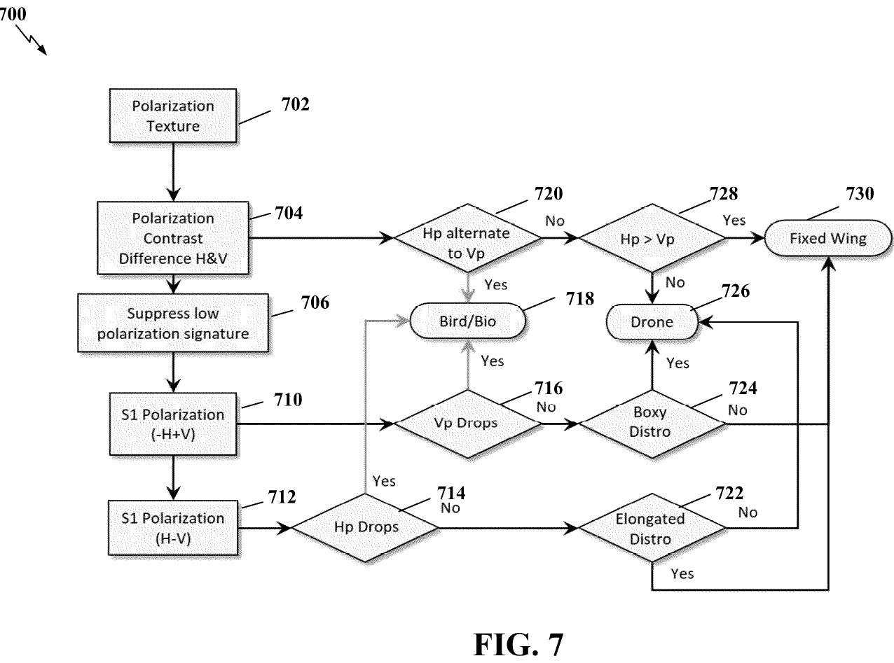

FIG. 7 illustrates a flow diagram of still another exemplary discrimination process or method according to aspects of the present disclosure. The illustrated discrimination algorithm 700 serves to discriminate between various detectable objects such as drones, birds or other biological creatures, or fixed wing aircraft by using polarization data (e.g., polarization texture) from images captured/observed in the system as shown by the exemplary call in block 702. The method 700 proceeds to block 704 where the polarization contrast difference between H & V polarization is examined. Flow proceeds to both blocks 706 and 708. At 706, the low polarization signature is suppressed. Next, the S1 polarization is determined/computed based on −H+V at block 710 and based on H−V at block 712. Flow then proceeds to blocks 714 and 716 to respectively determine if the horizontal polarization value Hp is dropping and the vertical polarization value Vp is dropping. If so to either, flow proceeds directly to block 718 as a bird/bio determination. Additionally, it is noted that if the Hp is an alternative to the Vp value as may be seen at block 720, flow proceeds directly to block 718 as a bird/bio determination.

If at blocks 714 or 716, there is not Vp or Hp drop, flow proceeds to respective blocks 722 and/or 724 to determine if the image has a boxy or elongated shape/distro. If boxy and/or not elongated, then a drone determination is made as shown at block 726. Also, at block 728, if the Hp value is not greater than the Vp value a drone determination is made. Alternatively, a fixed wind determination as shown at block 730 is made from block 722, 724, and/or 728 as illustrated.

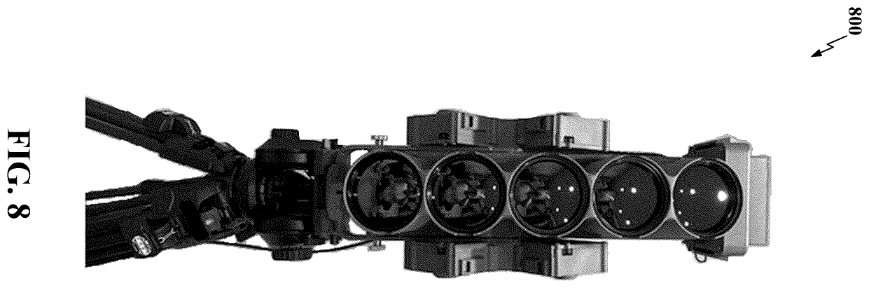

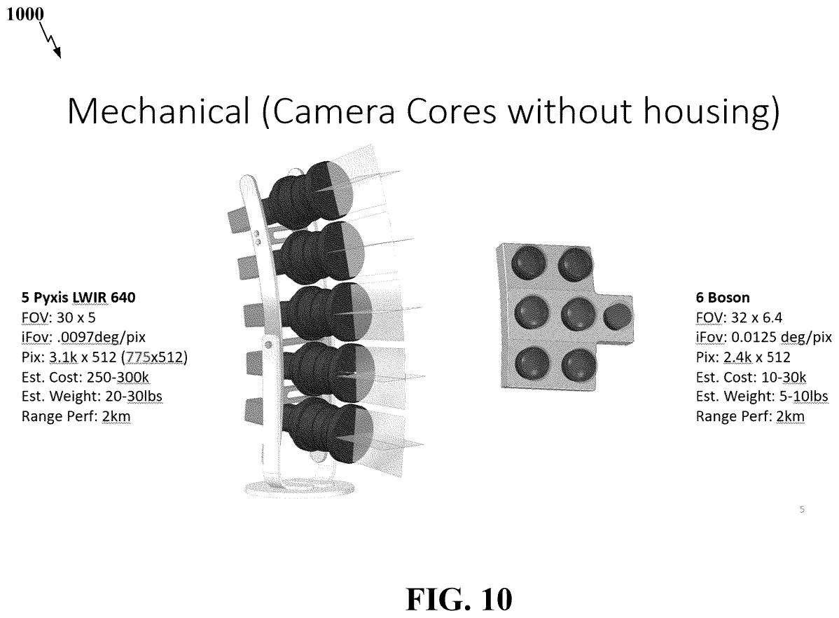

FIG. 8 illustrates a front view of at least a portion of an apparatus 800 for polarimetric imaging and detection according to aspects of the present disclosure, including various camera devices including cameras configured for obtaining polarization information. As will be described in more detail in connection with FIG. 10, apparatus 800 includes a number of various camera types according to various embodiments. Moreover, the apparatus is communicatively coupled with processor 100, as one example, although the processor 100 and coupling is not specifically illustrated in this figure.

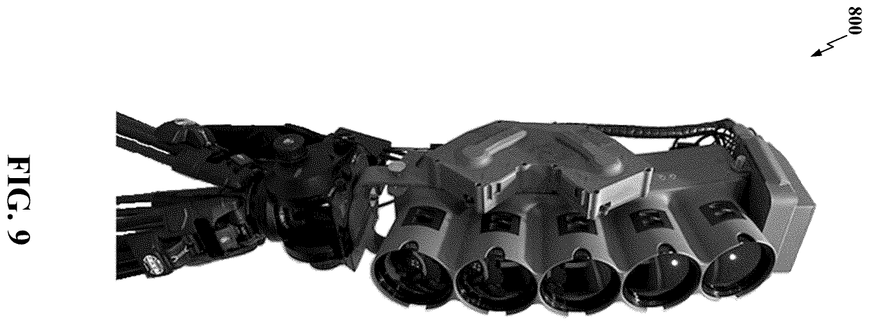

FIG. 9 illustrates a tri-metric side view of the apparatus 800 of FIG. 8 according to aspects of the present disclosure.

FIG. 10 illustrates an example of a layout or arrangement of camera arrays 1000 that may be used within the apparatus of FIGS. 8 and 9 according to aspects of the present disclosure. As may be seen, various cameras and manufacturers may be utilized and the particular electro-optical and infrared cameras, including SWIR, MWIR, LWIR, polarization cameras, polarizers, and/or forward looking infrared (FLIR) cameras. Those cameras shown in FIG. 10 are only exemplary, and other types and numbers of cameras are contemplated and may be used in the present system. Of note here, the example of FIG. 101 uses a two mega pixel Pyxis LWIR camera exploiting Raytheon Vision System's 1920×1280 microbolometer. The current resolution of the 2 MP Pyxis is 640×512 per camera. Further, the disclosed polarimetric system provides passive detection for tracking and UAV classification using stationary (non-rotating) thermal imagers with polarimetric sensors allowing possible radar replacement.

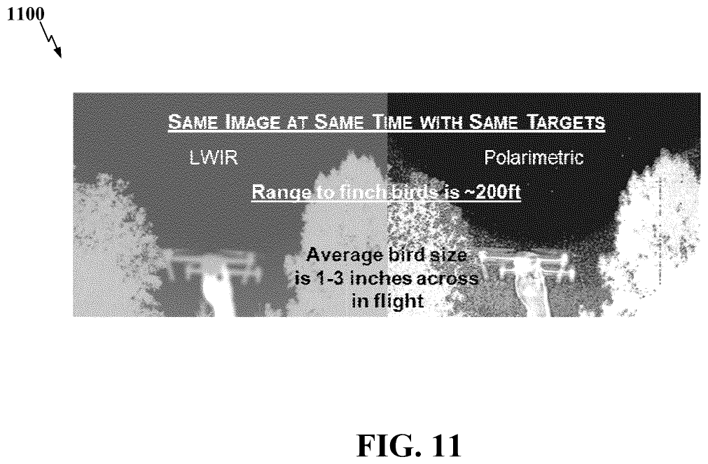

FIG. 11 illustrates an exemplary image 1100 comparing long wave infrared (LWIR) imaging with polarimetric imaging produced with processes or methods according to aspects of the present disclosure. To highlight the unique efficacy of polarimetric imaging, FIG. 11 is an example of the same image as seen through a standard long wave infrared camera (LWIR) versus a Polarimetric camera. A noteworthy aspect of the image is the signal to noise ratio of the background to both the drone in the foreground and the birds against a black sky. Polarimetric imaging with the presently disclosed physics based algorithms are capable of pulling out targets at further distances than traditional thermal imaging and provide a substantial amount of information from which to perform enhanced detection, discrimination, and tracking.

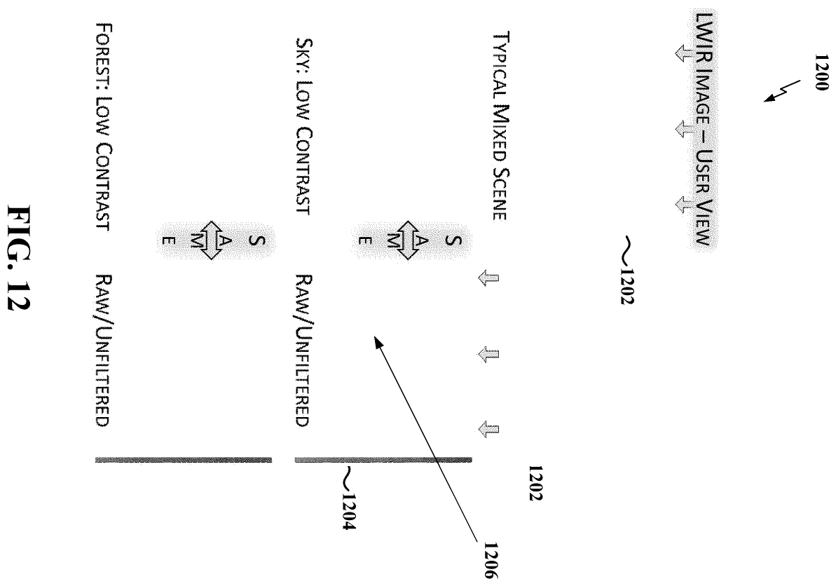

FIG. 12 illustrates an example 1200 of a comparison of images generated using LWIR imaging (left column) and polarimetric imaging (right column) according to aspects of the present disclosure. The mixed scene that is captured by an LWIR camera is shown at 1202. With a polarization camera or LWIR with a polarizer lens, filter, etc., the sky as shown in the row with image 1204 shows performance increase where detection of an object 1206 is increased or enhanced. Again, it is noted that the present system affords detection of a UAV from six (6) times further away by using polarized light opposed to an equivalent infrared imager. The performance increase illustrated here is the result of increasing target contrast against the background. The sky has a uniform distribution of polarization and the materials a UAV are made of reflect a strong polarization signature. When a polarizer is used with a camera, such as an LWIR camera, the background polarization of the sky is reduced by half while maintaining nearly all of the viewed UAV's polarimetric signature, making it possible to detect the presence of a UAV and to track it or with software to discriminate a drone from a plane from biological “things” like birds.

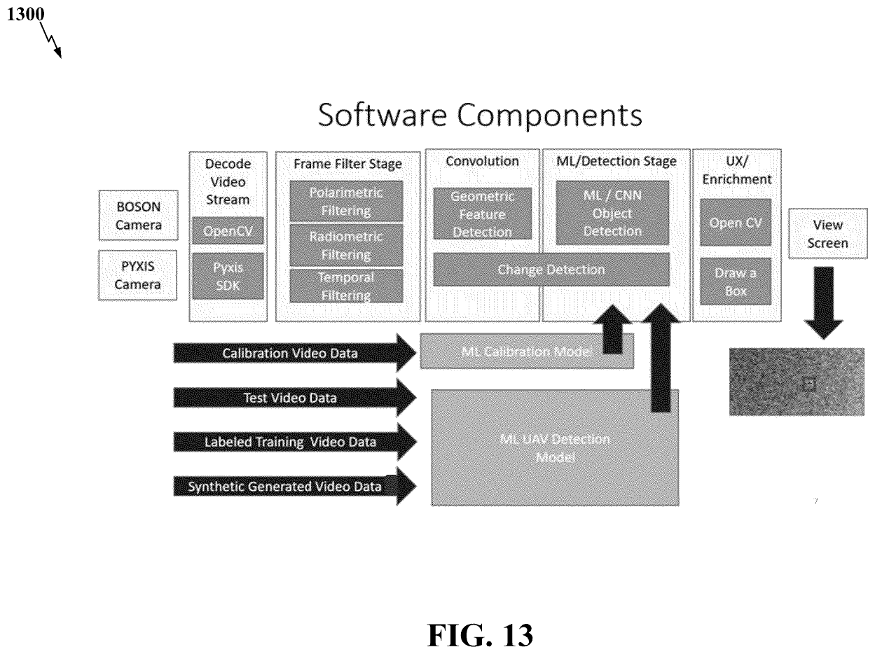

FIG. 13 illustrates an exemplary block diagram of software modules/functions and hardware implemented in the system according to aspects of the present disclosure. The algorithms/software makes it possible to detect and track drones while discriminating and ignoring biologicals and geology such as clouds, birds, trees, and landscape features. As shown in FIG. 13, core features of the software/processing system include one or more of: Spatial Filtering (object size); Temporal Filtering (the way it moves); Frame to Frame Fourier filtering (the way it move across/within time); Change Detection (differences in the scene); Polarimetric Contrast Leveling (signal enhancer and clutter reduction); Target Heading Tracking (track where it has been and where it is going); Biologic Discrimination (ignore birds and “stuff” that should be there); Self-Calibration (no user required); Bearing and Distance of/to threat/object (where is the “thing” relative to me); Range finding (DoD rules dependent); and GUI with object/threat marking (how the software “tells” the user). The current software utilized may be a physics based non-AI/ML solution, although the system may also be implemented with an AI/ML solution, but may depend on processing time concerns. For example, an AI/ML solution takes around 0.5 seconds (2 frames per second) to do what the physics based model may do at a rate of 15/30 frames per second.

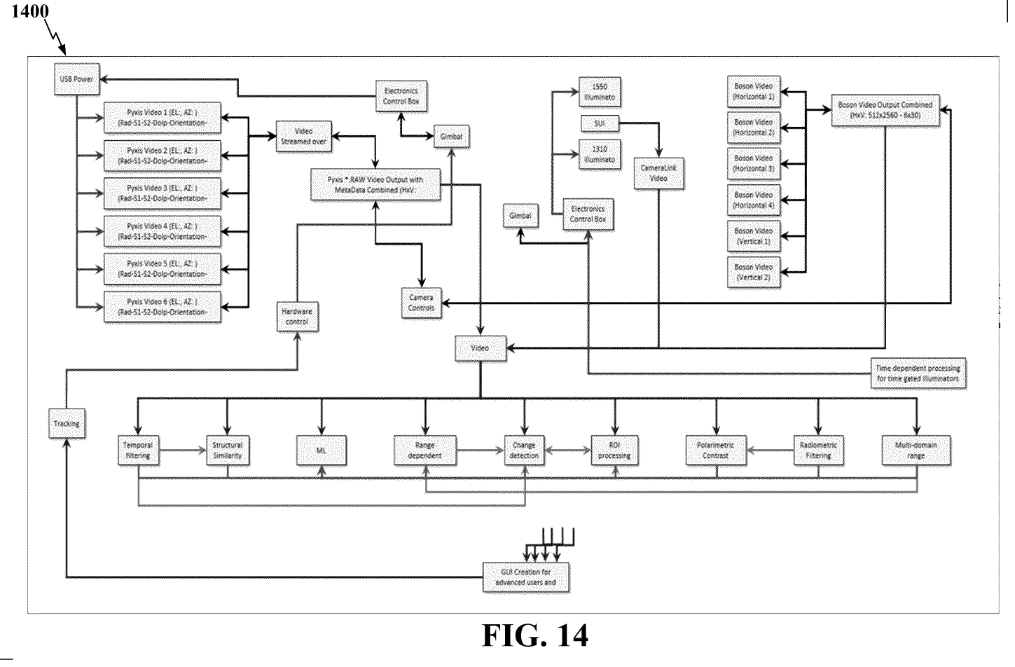

FIG. 14 illustrates an exemplary block diagram 1400 of further software architecture/components implemented in the system according to aspects of the present disclosure. As illustrated, the various power connections, control connections for the cameras, gimbals, etc., and communication connections to the cameras (merely exemplary types as shown and capable of substitution with like devices) and processing elements. Also, various functionalities discussed before are shown such as temporal filtering, tracking, structural similarity comparison, machine learning (ML), range dependency, change detection, ROI processing, polarimetric contrast, radiometric filtering, multi-domain range, GUI creation, etc. are illustrated. Of further note, FIG. 14 illustrates the provision of a unique, low latency network system architecture that overcomes existing latency and network delays presented by commercial off the shelf (COTS) available architectures of TCP/IP and User Datagram Protocol (UDP) interfaces. In the apparatus, custom UDP protocols are combined with were combined with a novel data transmission pipeline to ensure that system latency was minimized and image delays were nominal for very large data structures.

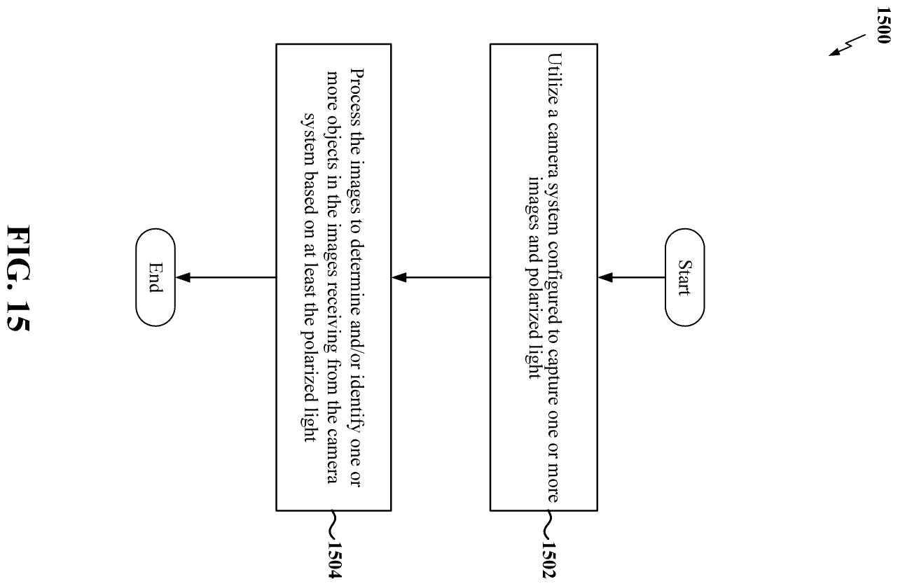

FIG. 15 illustrates a flow diagram of an exemplary method 1500 for detection, classification, discrimination, and/or identification of objects. As shown, method 1500 includes utilizing a camera system configured to capture one or more images using at least polarized light as shown in block 1502. Furthermore, method 1500 includes processing the images to determine and/or identify one or more objects in the images receiving from the camera system based on at least the polarized light as shown in block 1504.

The present apparatus may be configured as a passive detection system that uses SWIR/LWIR images to detect UAVs against the sky. The material that UAVs are made of strongly reflect polarized light, which make it possible to image the sky, detect objects reflecting polarized light, and determine objects of interest (i.e. UAVs).

It is possible to detect a UAV from approximately at least six (6) times further away by using polarized light opposed to an equivalent infrared imager. The performance increase is the result of increasing target contrast against the background. The sky has a uniform distribution of polarization and the materials a UAV are made of reflect a strong polarization signature. When a polarizer is used, the background polarization of the sky is reduced by half while maintaining nearly all of the viewed UAV's polarimetric signature, making it possible to detect the presence of a UAV and to track it or with software to discriminate a drone from a fixed wing aircraft from biological “things” like birds.

The polarimetric system may also be configured to provide passive detection for tracking and UAV classification using stationary (non-rotating) thermal imagers with polarimetric sensors allowing possible radar replacement.

Of further note, it will be evident to those skilled in the art that there are at least two aspects of the system that are of particular import: 1) the physical drone tracking system of cameras and hardware, and 2) the software that cleans up images from the sensors and discriminates/identifies objects of interest.

Concerning optical performance improvements, surveys of the relevant literature surveys of publications spanning indicate a maturity in the design performance of hyper hemispheric optics, which are a technology that may be implemented herein to permit the proposed azimuth and elevation fields of regard.

Concerning SWIR imaging, investments made in high resolution SWIR imaging systems, which are primarily marketed to aerial platforms, have made SWIR cameras more reliable, smaller, more energy efficient, more cost efficient, with higher resolution than was known before. The present system utilizes these advanced optical imaging systems to see further with higher sensitivity and greater dynamic ranges than prior imagers, while improving the system signal to noise. Further, commercial off the shelf (COTS) laser power compared to package size has seen breakthroughs in small form factor high power, energy efficient lasers that may be utilized in the presently disclosed systems and apparatus.

In yet other aspect, the present apparatus may employ a custom hardware platform for software, wherein hardware size, weight, and power (SWaP) and processing power are also improved. An exemplary ruggedized platform was utilized in embodiment that is among the first in its class to offer a high performance hardware solution capable of handling the computational loads of the required modern detection algorithms.

Application of the present apparatus and methods may also include countering mines. The technology may also be used to do detailed vulnerability analysis on various equipment.

Although the presently disclosed invention has been described in detail with reference to certain examples or embodiments, variations and modifications exist within the spirit and scope of the invention as described and defined in the following claims.

1. An apparatus for detection, classification, discrimination, and/or identification of objects, the apparatus comprising:
a camera system configured to capture one or more images including capturing polarized light; and
at least one processor communicatively coupled with the camera system and configured to receive the one or more images from the camera system and process the images to determine or identify one or more objects in the one or more images received from the camera system based on at least the polarized light.

2. The apparatus of claim 1, further comprising:
the camera system including one or more polarimetric sensors for detecting the polarized light.

3. The apparatus of claim 2, further comprising:
the camera system including stationary, non-rotating, thermal imagers.

4. The apparatus of claim 1, further comprising:
the at least one processor further configured to differentiate the object from among a plurality of objects including a fixed wing aircraft, a bird or other biologic creature, or a drone device.

5. The apparatus of claim 1, further comprising:
the at least one processor configured to implement:
a first operation mode comprising passive detection, tracking, and object classification; and
a second mode operation performing long range interrogation once an object of potential interest is detected during the first mode of operation.

6. The apparatus of claim 1, further comprising:
the at least one processor configured to determine one or more thermal characteristics in the one or more images for differentiating the object.

7. The apparatus of claim 1, further comprising:
a low latency network system architecture.

8. The apparatus of claim 7, further comprising:
the low latency network system architecture comprising UDP protocols in combination with a data transmission pipeline configured to ensure lower system latency.

9. A method for detection, classification, discrimination, and/or identification of objects, the method comprising:
utilizing a camera system configured to capture one or more images and polarized light;
processing the images to determine and/or identify one or more objects in the images received from the camera system based on at least the polarized light.

10. The method of claim 9, further comprising:
operating according to a first mode including passive detection, tracking, and UAV classification using stationary, non-rotating, thermal imagers with polarimetric sensors; and
operating according to a second mode including long range interrogation after object of potential interest is detected using the first mode.

11. The method of claim 9, further comprising:
the camera system including one or more polarimetric sensors for detecting the polarized light.

12. The method of claim 11, further comprising:
the camera system including stationary, non-rotating, thermal imagers.

13. The method of claim 9, further comprising:
differentiating the object from among a plurality of objects including a fixed wing aircraft, a bird or other biologic creature, or a drone device.

14. The method of claim 13, further comprising:
determining one or more thermal characteristics in the one or more images for differentiating the object.

15. The method of claim 9, further comprising:
employing a low latency network system architecture.

16. The method of claim 15, further comprising:
the low latency network system architecture comprising UDP protocols in combination with a data transmission pipeline configured to ensure lower system latency.
